(19) United States
(12) Patent Application Publication
(10) Pub. No.: US 2012/0239254 A1
(43) Pub. Date: Sep. 20, 2012

(54) METHOD FOR OPERATING A POWER STEERING

(76) Inventors: Arnulf Heilig, Schwaebisch Gmuend (DE); Claudio Rettenmeier, Ellwangen (DE)

(21) Appl. No.: 13/462,337

(22) Filed: May 2, 2012

Related U.S. Application Data
(63) Continuation of application No. PCT/EP2010/066053, filed on Oct. 25, 2010.

(30) Foreign Application Priority Data
Nov. 4, 2009 (DE) 10 2009 046 379.8
Mar. 12, 2010 (DE) 10 2010 002 803.7

(51) Int. Cl. B62D 6/08; B62D 5/04

(52) U.S. Cl. 701/41; 180/446

(57) ABSTRACT

Disclosed is a method for operating a power steering system and to such a power steering system. A manual torque predetermined by a driver is superimposed in a superposition unit with a motor torque created by a motor. Impairment of the power steering system can thus be detected by evaluating rotational speed patterns of the motor.

### BACKGROUND OF THE INVENTION

The invention relates to a method for operating a power steering system and to such a power steering system.

Power steering systems are known, which superimpose a manual torque applied by a driver with a motor torque using a motor. Because the power steering system is typically installed outside, it is exposed to external influences, and more particularly environmental and temperature influences. This may impair the functional capability of the steering system. Notably freezing of the power steering system resulting from water penetration poses a particular problem.

It is known to provide a steering housing with a water drain valve, notably in the case of an axially parallel arrangement, which opens when water enters and assures that the water which has penetrated into the steering gear can drain and the steering system cannot freeze at low temperatures.

The published prior art WO 2008/116555 A1 discloses an electromechanical system and a method for detecting the onset of freezing of an electromechanical system, and a motor vehicle comprising an electromechanical system. The electromechanical system comprises an electric motor, at least one mechanical element moved by the electric motor, and a controller. The controller is supplied with at least one input variable, wherein the controller determines a target variable for the electric motor based on the input variable. According to the invention, a controlled variable of the mechanical element is ascertained and transmitted to the controller, wherein a stick-slip effect is ascertained based on the comparison of the target variable for the electric motor to the controlled variable of the mechanical system. Moreover, a temperature sensor, a moisture sensor and a so-called stick-slip detector are described as means suitable for detecting the risk of thickening or freezing of a working fluid or a liquid that has penetrated into the electromechanical system. A stick-slip detector can, for example, be a means for recording noise or structure-borne sound.

The object is therefore to propose a method for operating a power steering system, by which impairment of the power steering system can be easily detected. To this end, it is in particular desired to detect impairment as early as possible, or as soon as the onset of any impairment.

According to the described method for operating a power steering system, a manual torque, which is predetermined by a driver, is superimposed with a motor torque applied by a motor in a superposition unit. An impairment of the power steering system is detected by evaluating rotational speed patterns of the motor.

The method presented notably suitable for detecting freezing of the power steering system, in the steering system or the steering gear.

It is advantageous to take an identified friction coefficient into consideration.

In addition, further boundary conditions, such as a rotor rotational speed, a manual torque, a nominal motor torque, a steering angle, a vehicle speed, an output stage temperature (ECU), an outside temperature and/or a gearbox sign indicator, may be included.

In one embodiment, the effective direction of the manual torque and the effective direction of the motor torque are taken into account. To this end, it is noted whether the manual torque and the motor torque, which create the effective torque, act in the same direction. This is favorable in terms of the robustness of the method, because it makes it possible to check whether the detected rotational speed pattern is due to actuation by the driver and not caused by external disturbance.

Initiating corrective measures when impairment is detected is an obvious choice. One example is that of applying an oscillating motor torque. Moreover, a warning signal (visual and/or acoustic) can be emitted.

The described power steering system comprises a steering handle for predetermining a manual torque, a motor, typically an electric motor, and a superposition unit, which superimposes the manual torque predetermined by a driver with a motor torque of the motor. The power steering system is characterized in that impairment of the power steering system can be detected by evaluating rotational speed patterns of the motor.

In one embodiment, a controller is provided which ascertains and evaluates the rotational speed patterns of the motor.

A method is thus described which, in one embodiment, detects freezing of the steering system based on rotational speed patterns and identified friction. So as to prevent a dangerous condition, an oscillating motor torque can be applied, as a result of which the freezing steering system can be more easily controlled and will not freeze completely.

The risk of thickening or freezing of a working liquid or a liquid that has penetrated into the power steering system can thus be detected.

The described method can be carried out in a microprocessor or in a processor of a controller. In this example, the method is implemented in software or a computer-implemented algorithm, which is carried out automatically and ascertains and processes technical quantities.

The input variables of the algorithm can be the rotor rotational speed, absolute rotor rotational speed, manual torque, nominal motor torque, absolute steering angle, typically filtered vehicle speed, output stage temperature of the ECU, gearbox sign, and identified friction coefficient.

If the steering system begins to freeze during driving, specific rotational speed patterns develop, which the software that is used in the controller can detect. If the steering system is not frozen, the steering by the driver effects a substantially continuous progression of the rotor rotational speed.

In a typical scenario, If the steering system begins to freeze, the rotational speed will be very low (<5 rpm) for approximately 100 ms, then the steering system will be “freed up” again as a result of steering by the driver, causing a brief discontinuity in the rotational speed. The steering system then easily freezes again, which results in a very low rotational speed for a short period of time. If this rotational speed pattern consecutively occurs multiple times, for example ten times, and other boundary conditions are met, such as a temperature of <+5° C., system friction >0.2 Nm and the like, freezing of the steering system is detected.

After detection, an oscillating motor torque can be applied, which prevents further freezing and thereby considerably improves the ability to control the vehicle because the stick-slip effects encountered during freezing no longer occur. The oscillating moment is also used for haptic feedback to and for the driver so as to warn the same.

It is thus possible for the driver to better control the freezing steering system, so that it does not freeze completely.

After freezing has been detected, for example a warning lamp and/or an acoustic signal can be activated.

According to a particular embodiment, a rotor rotational speed and/or a manual torque and/or a nominal motor torque and/or a steering angle and/or a vehicle speed and/or an output stage temperature of the ECU and/or an outside temperature and/or a circuit board temperature and/or a gearbox sign indicator and/or a determined friction coefficient can be provided as input variables of the computer-implemented method.

The computer program presented comprises program code means for carrying out all of the steps of a method, as described above, when the computer program is executed on a computer or a corresponding processor.

The computer program product comprises these program code means, which are stored on a computer-readable data medium.

This computer program can be stored on a computer-readable data medium, such as a diskette, CD, DVD, hard drive, USB memory stick or the like, or on an Internet server as a computer program product. From there, the computer program can be transferred to a memory element of the control unit.

Further advantages and embodiments of the invention will be apparent from the description and the accompany drawings.

The above characteristics and those described below can, of course, be used not only in the respectively described combinations, but also in other combinations, or alone, without departing from the scope of the present invention.

The invention is schematically illustrated in the drawings based on an exemplary embodiment and will be described in detail hereafter with reference to the drawings.

### BRIEF DESCRIPTION OF THE DRAWINGS

FIG. 1 is a schematic illustration of one embodiment of the power steering system presented.

FIG. 2 shows a rotational speed curve with discontinuities.

FIG. 3 shows a discontinuity of a rotational speed curve.

### DESCRIPTION OF THE PREFERRED EMBODIMENTS

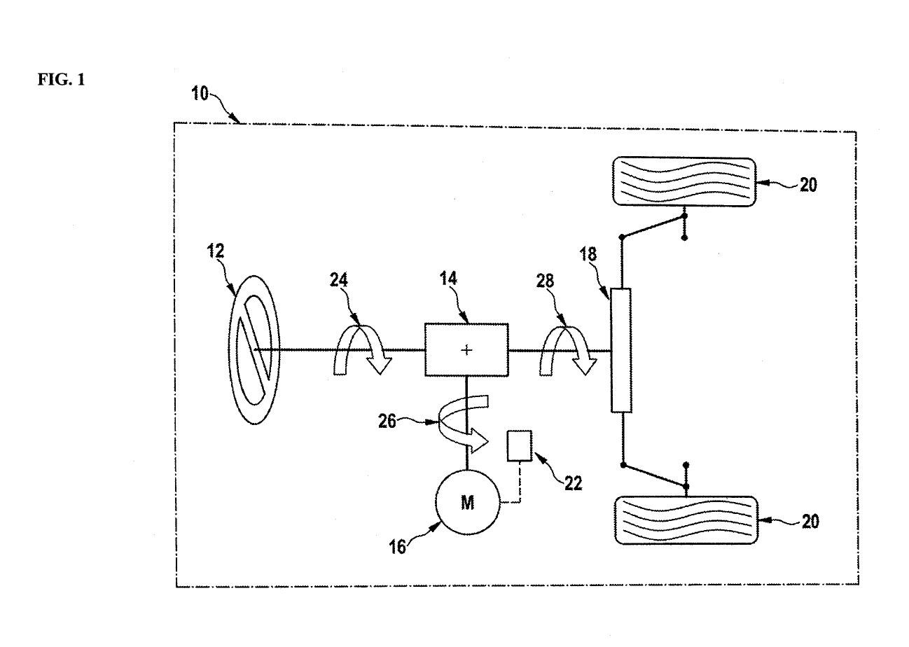

FIG. 1 illustrates a power steering system which, in the overall, is denoted by reference numeral 10.

The illustration shows a steering handle 12, which is designed as a steering wheel, a superposition unit 14, which is associated with a motor 16 for torque superposition, a toothed rack 18, two articulated wheels 20, and a controller 22 associated with the motor 16.

The steering handle 12 predetermines a manual torque 24. This manual torque 24 is superimposed with a motor torque 26 created by the motor 16, in the superposition unit 14. This results in an effective torque 28, which is present at the toothed rack 18 and by which the wheels 20 are steered.

In addition to actuating the motor 16, the controller 22 is designed to ascertain rotational speed patterns, which is to say a specific progression of the rotational speed, of this motor 16. These rotational speed patterns are evaluated whereby detection is made of whether or not impairment or freezing of the power steering system 10 is present. If impairment is detected, corrective measures are initiated, such as an oscillating action on the power steering system 10 by the motor 16. In addition, a warning is issued to the driver.

A variety of additional boundary values or conditions, such as a friction coefficient, for example, can be considered in the evaluation. In particular whether or not the manual torque 24 and motor torque 26 act in the same direction is also checked. Otherwise the detected specific rotational speed pattern could be attributable to other influences, such as roughness of the roadway, and not to actuation by the driver.

In any case, initiating corrective measures only when the specific rotational speed pattern was detected several times consecutively within a certain time period is an obvious choice. For this purpose, for example, a counter can be employed, which is reset after a certain time period, for example by way of a timer.

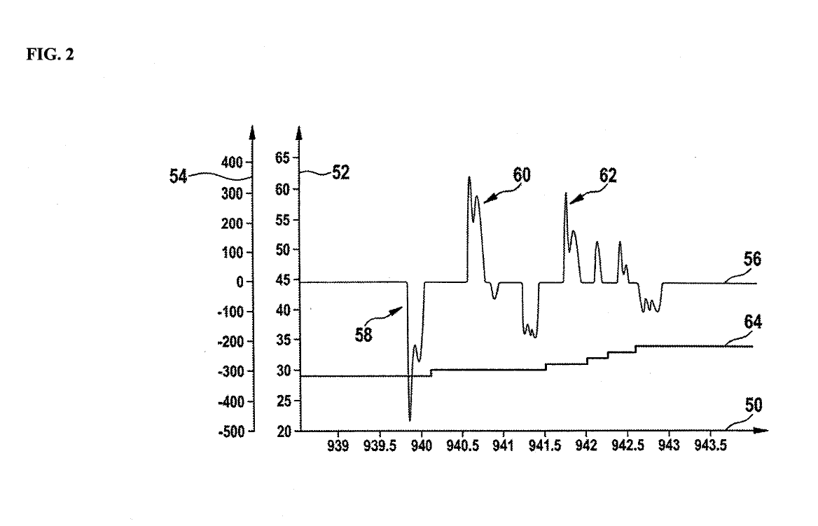

FIG. 2 shows a rotational speed curve having discontinuities over time. The time is plotted in ms on an abscissa 50, the value of a counter is plotted on a first ordinate 52, and the rotational speed is plotted in revolutions per minute on a second ordinate 54.

The illustration shows a curve 56 representing a rotational speed progression, which in turn comprises a number of rotational speed patterns 58, 60 and 62. In this example, certain characteristic discontinuities in the curve 56 are detected as rotational speed patterns 59, 60 and 62, which are typical of a stick-slip effect. As soon as such a characteristic rotational speed pattern 58, 60 and 62 has been detected, a counter is incremented, as another curve 64 illustrates. The number of certain rotational speed patterns, or the number of characteristic discontinuities in the curve 56, and thus in the progression of the rotational speed, is thus ascertained. Once the counter reaches a certain predeterminable level, freezing is detected, and suitable measures are initiated. However, the counter is reset after a certain time span has expired so as to assure reliable operation.

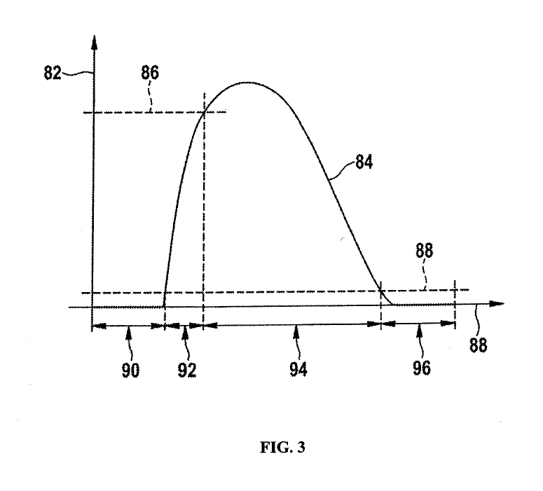

FIG. 3 shows a discontinuity in a rotational speed progression. The time is plotted in ms on an abscissa 80. The progression of the rotational speed is plotted in revolutions per minute on an ordinate 82.

A curve 84 shows a discontinuity in the progression of the rotational speed. A threshold 86 indicates an upper rotational speed threshold, and another threshold 88 indicates a lower rotational speed threshold. A first time range 90 indicates the minimum time for the lower rotational speed, another time range 92 indicates a maximum time until the upper rotational speed is reached, yet another time range 94 indicates a maximum time until the lower rotational speed is reached again, and still another time range 96 indicates a minimum time for the lower rotational speed. Thus, the curve 84 is analyzed, and the discontinuities in this curve are analyzed. In this way, characteristic rotational speed patterns are determined.

1. A method for operating a power steering system of a motor vehicle, in which a predetermined manual torque is superimposed in a superposition unit by a motor torque applied by a motor, impairment of the power steering system is being detected by evaluating rotational speed patterns of the motor.

2. The method according to claim 1, wherein freezing of the power steering system is detected.

3. The method according to claim 2, wherein an identified friction coefficient is taken into consideration.

4. The method according to claim 2, wherein further boundary conditions are included.

5. The method according to claim 3, wherein the effective direction of the manual torque and the effective direction of the motor torque are taken into consideration.

6. A method according to claim 1, wherein corrective measures are initiated when impairment is detected.

7. A power steering system comprising a steering handle for predetermining a manual torque; and a superposition unit with which the predetermined manual torque is superimposed with a motor torque of a motor, the power steering system being arranged such that impairment of the power steering system is detected by evaluating the rotational speed patterns of the motor.

8. The power steering system according to claim 7, comprising a controller which ascertains and evaluates the rotational speed pattern of the motor.

9. A computer program comprising program code means for carrying out a method according to claim 1, if the computer program is executed on a microprocessor of a computer, in particular in a controller which ascertains and evaluates the rotational speed pattern of a motor.

10. A computer program comprising program code means which are stored on a computer-readable data medium, for carrying out a method according to claim 1, if the computer program is executed on a microprocessor of a computer, in particular in a controller which ascertains and evaluates the rotational speed pattern of a motor.
